(19) United States
(12) Patent Application Publication
(10) Pub. No.: US 2018/0043619 A1
(43) Pub. Date: Feb. 15, 2018

(54) 3D PRINTING APPARATUS

(71) Applicant: LG ELECTRONICS INC., Seoul (KR)

(72) Inventors: Hyoungseok KIM, Seoul (KR); Kyujin CHOI, Seoul (KR)

(21) Appl. No.: 15/557,989

(22) PCT Filed: Jun. 3, 2015
(86) PCT No.: PCT/KR2015/005592

§ 371 Date: Sep. 13, 2017

(30) Foreign Application Priority Data
Mar. 20, 2015 (KR) 10-2015-0039105

(51) Int. Cl. B29C 64/357; B33Y 30/00; B33Y 40/00; B29C 64/264

(52) U.S. Cl. CPC B29C 64/357; B29C 64/264; B33Y 30/00; B33Y 40/00

(57) ABSTRACT

A three-dimensional (3D) printing apparatus is provided. The 3D printing apparatus includes a modeling material circulating part for circulating a modeling material for modeling a 3D model, a light source unit disposed on one side of the modeling material circulating part to supply light toward the modeling material so that the modeling material is cured, a stage on which the modeling material cured through the light source unit is seated, the stage being disposed to face the modeling material circulating part, a stage driving part connected to the stage to provide a driving force for moving the stage, a modeling material supply part for supplying the modeling material to the modeling material circulating part, a modeling material collecting part for collecting the modeling material, which passes through the light source unit, of the modeling material circulating by the modeling material circulating part, and a modeling material recycling part connected to the modeling material collecting part to filter the collected modeling material to resupply the filtered modeling material to the modeling material circulating part.

### TECHNICAL FIELD

The present disclosure relates to a three-dimensional (3D) printing apparatus.

### BACKGROUND ART

Three-dimensional (3D) printing apparatuses are apparatuses for building three-dimensional objects, but not two-dimensional objects such as letters or pictures, on the basis of inputted design drawings. Such a 3D printing apparatus has been started in some of industries for modeling an object before mass production or manufacturing a sample and is gradually expanding its application range to a domestic, educational, or medical use these days.

A 3D printing apparatus according to the related art is disclosed in Korean Patent Registration Gazette No. 10-1451794. The 3D printing apparatus is classified in various manners in addition to a manner disclosed in the Gazette according to an operation manner. In detail, there are a liquid-based stereolithography (SLA) manner, a solid-based fused deposition modeling (FDM) manner, an inkjet manner, a selective laser sintering (SLS) manner, a laminated object manufacturing (LOM) manner, an electron beam melting (EBM) manner, and a direct metal laser sintering (DMLS) manner.

In the 3D printing apparatus according to the related art, generally, a modeling material remaining after being used for modeling a 3D model is discarded. In the 3D printing apparatus, most of the costs are incurred due to the modeling material. The costs for the modeling material may be a big burden on a user.

Therefore, it is necessary to find a solution for using the modeling material remaining after being used for modeling the 3D model in the 3D printing apparatus.

### DISCLOSURE OF INVENTION

### Technical Problem

Embodiments provide a three-dimensional (3D) printing apparatus that is capable of recycling a modeling material remaining after being used for modeling a 3D model.

### Solution to Problem

In one embodiment, a three-dimensional (3D) printing apparatus includes: a modeling material circulating part for circulating a modeling material for modeling a 3D model; a light source unit disposed on one side of the modeling material circulating part to supply light toward the modeling material so that the modeling material is cured; a stage on which the modeling material cured through the light source unit is seated, the stage being disposed to face the modeling material circulating part; a stage driving part connected to the stage to provide a driving force for moving the stage; a modeling material supply part for supplying the modeling material to the modeling material circulating part; a modeling material collecting part for collecting the modeling material, which passes through the light source unit, of the modeling material circulating by the modeling material circulating part; and a modeling material recycling part connected to the modeling material collecting part to filter the collected modeling material to resupply the filtered modeling material to the modeling material circulating part.

The light source unit may be disposed inside the modeling material circulating part.

Each of the modeling material collecting part and the modeling material recycling part may be disposed outside the modeling material circulating part.

The modeling material circulating part may include: a circulation belt on which the modeling material is seated, the circulation belt circulating the modeling material; and a plurality of belt rollers disposed inside the circulation belt to provide driving forces to the circulation belt.

The light source unit may be disposed inside the circulation belt, and each of the modeling material collecting part and the modeling material recycling part may be disposed outside the circulation belt.

The modeling material circulating part may further include a plurality of roller sensors for controlling RPM and moving distance of each of the plurality of belt rollers.

The light source unit may be movably disposed along a longitudinal direction of the circulation belt.

The modeling material collecting part may include: at least one collection blade disposed adjacent to the circulation belt to separate the modeling material from the circulation belt; a suction unit connected to the at least one collection blade to suction the modeling material separated from the at least one collection blade; and a connecting unit for connecting the suction unit to the modeling material recycling part so that the modeling material suctioned through the suction unit is supplied to the modeling material recycling part.

The collection blade may be provided in plurality, and the plurality of collection blades may be disposed a predetermined distance apart from each other.

The suction unit may include: a suction unit body connected to the collection blade to suction the modeling material; and a compressor connected to the suction unit body to provide compressed air to the suction unit body so that the suction unit body suctions the modeling material.

The modeling material recycling part may include: a filter unit connected to the modeling material collecting part to filter the modeling material supplied from the modeling material collecting part; a resupply unit connected to the filter unit to resupply the modeling material filtered from the filter unit to the modeling material circulating part; and a waste container connected to the filter unit to accommodate the modeling material except for the filtered modeling material.

The resupply unit may be integrated with the modeling material supply part.

The resupply unit may be disposed a predetermined distance apart from the modeling material supply part.

The light source unit may include an LED array including a plurality of LEDs.

The modeling material may be a photocurable liquid resin composition.

The details of one or more embodiments are set forth in the accompanying drawings and the description below. Other features will be apparent from the description and drawings, and from the claims.

### Advantageous Effects of Invention

According to the above-described various embodiment, the 3D printing apparatus capable of recycling the modeling material remaining after being used for modeling the 3D model may be provided.

Thus, the 3D printing apparatus that is significantly reduced in costs for the modeling material, which is most of the total costs of the 3D printing apparatus, may be provided.

### BRIEF DESCRIPTION OF DRAWINGS

FIG. 1 is a view illustrating a three-dimensional (3D) printing apparatus according to an embodiment.

FIG. 2 is a view illustrating another embodiment of a modeling material recycling part of the 3D printing apparatus of FIG. 1.

FIG. 3 is a view illustrating an operation of the 3D printing apparatus of FIG. 1.

FIG. 4 is a view illustrating a 3D printing apparatus according to another embodiment.

FIGS. 5 to 11 are views illustrating various embodiments in which the 3D printing apparatus of FIG. 1 is controlled by a mobile device.

### MODE FOR THE INVENTION

Reference will now be made in detail to the embodiments of the present disclosure, examples of which are illustrated in the accompanying drawings. In the following description, the technical terms are used only for explain a specific exemplary embodiment while not limiting the present invention. Therefore, it will be understood that the embodiments disclosed in this specification includes some variations without limitations to the shapes as illustrated in the figures. In addition, the sizes of the elements and the relative sizes between elements may be exaggerated for further understanding of the present invention.

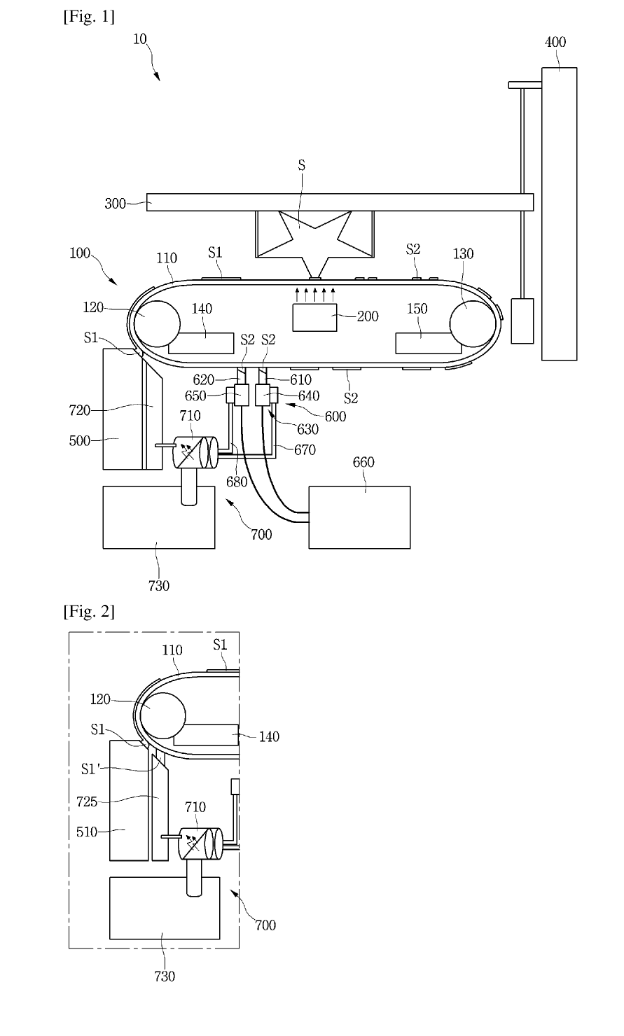

FIG. 1 is a view illustrating a three-dimensional (3D) printing apparatus according to an embodiment, and FIG. 2 is a view illustrating another embodiment of a modeling material recycling part of the 3D printing apparatus of FIG. 1.

Referring to FIG. 1, a three-dimensional (3D) printing apparatus 10 includes a modeling material circulating part 100, a light source unit 200, a stage 300, a stage driving part 400, a modeling material supply part 500, a modeling material collecting part 600, and a modeling material recycling part 700.

The modeling material circulating part 100 circulates modeling materials S1 and S2 for modeling a 3D model S. Here, the modeling materials S1 and S2 may be a photocurable liquid resin composition. Various photocurable liquid resin compositions may be used for the modeling materials S1 and S2 in consideration desired quality when the 3D model is modeled.

The modeling material circulating part 100 includes a circulation belt 110, a plurality of belt rollers 120 and 130, and a plurality of roller sensors 140 and 150.

The modeling materials S1 and S2 are seated on the circulation belt 110, and the circulation belt 110 may circulate the modeling materials S1 and S2 seated thereon.

The circulation belt 110 may be formed of a transparent material so that light of the light source unit 200 that will be described later penetrates therethrough.

Each of the plurality of belt rollers 120 and 130 are disposed inside the circulation belt 110 to provide a driving force for a circulating operation of the circulation belt 110. The plurality of belt rollers 120 and 130 include a first belt roller 120 and a second belt roller 130.

The first belt roller 120 is disposed on one end of the inside of the circulation belt 110. The first belt roller 120 may guide the circulating operation of the circulation belt 110 by a rotating operation. Since the first belt roller 120 is similar to a general belt roller, hereinafter, detailed description of the first belt roller 120 will be omitted.

The second belt roller 130 is disposed on the other end of the inside of the circulation belt 110. The second belt roller 130 may guide the circulating operation of the circulation belt 110 by a rotating operation like the first belt roller 130. Since the second belt roller 130 is also similar to the general belt roller like the first belt roller 120, hereinafter, detailed description of the second belt roller 130 will be omitted.

The plurality of roller sensors 140 and 150 may control RPM and moving distance of each of the plurality of belt rollers 120 and 130. The plurality of roller sensors 140 and 150 include a first roller sensor 140 and a second roller sensor 150.

When the first belt roller 120 rotates, the first roller sensor 140 may detect and control the RPM and moving distance of the first belt roller 120. When the second belt roller 130 rotates, the second roller sensor 150 may detect and control the RPM and moving distance of the second belt roller 150.

When the 3D model S is modeled, the modeling material circulating part 100 may appropriately control a circulation speed of the circulation belt 110 according to the control of the RPM and moving distance of each of the first and second belt rollers 120 and 130 by each of the first and second roller sensors 140 and 150.

The light source unit 200 may supply the light toward the modeling material S1 so that the modeling material S1 is cured. The light source unit 200 is disposed on one side of the modeling material circulating part 100, particularly, in the modeling material circulating part 100. In the current embodiment, the light source unit 200 is disposed at an inner central side of the circulation belt 110.

Since the light source unit 200 is disposed inside the modeling material circulating part 100 instead of the outside of the modeling material circulating part 100, the 3D printing apparatus 10 according to the current embodiment may be reduced in volume by a space that is occupied by the light source unit 100 when compared to a case in which the light source unit is disposed outside the modeling material circulating part. Tus, the 3D printing apparatus 10 according to the current embodiment may be realized as a relatively slimmer 3D printing apparatus 10.

Also, the light source unit 200 includes a light emitting diode (LED) array constituted with a plurality of LEDs. The plurality of LEDs may be provided with ultra violet LEDs.

The plurality of LEDs may be constituted with LEDs having at least two

The plurality of LEDs may be constituted with LEDs having at least two wavelength bands. That is, the plurality of LEDs may have wavelength bands different from each other.

The modeling material S that is cured through the light source unit 200 is seated on the stage 300. The stage 300 is disposed to face the circulation belt 110 of the modeling material circulating part 100. In detail, the stage 300 and the light source unit 200 are disposed to face each other with the circulation belt 110 therebetween.

The stage driving part 400 is connected to the stage 300 to provide a driving force for movement of the stage 300. The stage driving part 400 may provide a driving force for 3-axis movement of the stage 300. Since the stage driving part 400 is well-known, hereinafter, detailed descriptions of the stage driving part 400 will be omitted.

The modeling material supply part 500 accommodates the modeling material S1 to supply the modeling material S1 to the modeling material circulating part 100. When the 3D model S is modeled, the modeling material supply part 500 may appropriately adjust a supply amount of the modeling material S1 according to a build size.

The modeling material supply part 500 is disposed adjacent to the circulation belt 110 of the modeling material circulating part 100. In the current embodiment, the modeling material supply part 500 is disposed adjacent to one outer end of the circulation belt 110. Thus, the modeling material S1 supplied from the modeling material supply part 500 may circulate along the circulation belt 110.

The modeling material collecting part 600 may collect the modeling material S2, which passes through the light source unit 200, of the modeling material S1 and S2 circulating by the modeling material circulating part 100. For this, the modeling material collecting part 600 is disposed outside the modeling material circulating part 100.

The modeling material collecting part 600 includes collection blades 610 and 620, a suction unit 630, and connecting units 670 and 680.

The collection blades 610 and 620 may separate the modeling material S2 from the circulation belt 110 of the modeling material circulating part 100. The collection blades 610 and 620 may be disposed adjacent to the outside of the circulation belt 110.

The collection blades 610 and 620 may be provided in single or plurality.

Hereinafter, in the current embodiment, it is limited to a case in which a plurality of collection blades 610 and 620. The plurality of collection blades 610 and 620 include a first collection blade 610 and a second collection blade 620.

The first collection blade 610 may firstly separate the modeling material S2 remaining after the modeling that passes through the light source unit 200 from the circulation belt 110. The second collection blade 620 may be disposed a predetermined distance apart from the first collection blade 610 to secondly separate the remaining modeling material S2 that is not collected by the first collection blade 610 from the circulation belt 110.

Thus, in the current embodiment, the additionally provided second collection blade 620 may further improve efficiency in which the modeling material S2 is separated from the circulation belt 110.

The suction unit 630 is connected to each of the first and second collection blades 610 and 620 to suction the modeling material S2 separated from the first and second collection blades 610 and 620.

The suction unit 630 includes suction unit bodies 640 and 650 and a compressor 660.

The suction unit bodies 640 and 650 are respectively connected to the first and second collection blades 610 and 620 to suction the separated modeling material S2. The suction unit bodies 640 and 650 include a first suction body 640 and a second suction body 650.

The first suction body 640 is connected to the first collection blade 610 to suction the modeling material S2 separated from the first collection blade 610. The first suction body 640 may be provided in a suction manner or a vacuum generation manner for suctioning. However, it is only an example, the first suction body 640 may be provided in other manners for suctioning.

The second suction body 650 is connected to the second collection blade 620 to suction the modeling material S2 separated from the second collection blade 620. The second suction body 650 may be provided in a suction manner or a vacuum generation manner for suctioning like the first suction body 640. However, it is only an example, the second suction body 650 may be provided in other manners for suctioning.

The compressor 660 is connected to the suction unit bodies 640 and 650, that is, each of the first and second suction bodies 640 and 650. The compressor 660 may provide compressed air to each of the first and second suction bodies 640 and 650 so that each of the first and second suction bodies 640 and 650 suctions the separated modeling material S2.

The connecting units 670 and 680 may supply the modeling material S2 suctioned through the first and second suction bodies 640 and 650 of the suction unit 630 to the modeling material recycling part 700 that will be described later. For this, the connecting units 670 and 680 connect the suction unit 630 to the modeling material recycling part 700.

The connecting units 670 and 680 include a first connecting tube 670 and a second connecting tube 680.

The first connecting tube 670 connects the first suction body 640 of the suction unit 630 to a filter unit 710 that will be described later. The second connecting tube 680 connects the second suction body 650 of the suction unit 630 to the filter unit 710 that will be described later. The modeling material suctioned through the first and second connecting tubes 670 and 680 may be supplied to the filter unit 710.

The modeling material recycling part 700 is disposed outside the circulation belt 110 of the modeling material circulating part 100 and connected to the modeling material collecting part 600. The modeling material recycling part 700 may filter the modeling material S2 collected from the modeling material collecting part 600 to resupply the filtered modeling material to the modeling material circulating part 500.

The modeling material recycling part 700 includes the filter unit 710, a resupply unit 720, and a waste container 730.

The filter unit 710 is connected to the modeling material collecting part 600, in detail, to each of the first and second connecting tubes 670 and 680 to filter the modeling material S2 supplied from the modeling material collecting part 600.

The filter unit 710 includes a filter of several ums. The supplied modeling material may be filtered by the filter unit 710 and thus be divided into a recyclable modeling material and an unrecyclable modeling material that needs to be discarded.

The resupply unit 720 is connected to the filter unit 710 to resupply the modeling material filtered from the filter unit 710 to the modeling material circulating part 100. The resupply unit 720 and the modeling material supply part 500 are integrated with each other. Thus, the filtered modeling material may be mixed with the modeling material in the modeling material supply part 500.

Then, the filtered modeling material supplied to the resupply unit 720 may be mixed with the modeling material of the modeling material supply part 500 and thus be supplied again to the modeling material circulating part 100. Here, the modeling material S1 supplied to the modeling material circulating part 100 may be a modeling material in which an original modeling material is appropriately mixed with the filtered modeling material at a desired ratio.

The filtered modeling material supplied to the resupply unit 720 may be separately supplied to the modeling material circulating part 100 without being mixed with the modeling material supply part 500. Also, referring to FIG. 2, the resupply unit 725 may be separately disposed with respect to the modeling material supply part 500. That is, the resupply unit 725 may be disposed a predetermined distance apart from the modeling material supply part. In this case, the filtered modeling material S1′ may be separately supplied to the modeling material circulating part with respect to the modeling material S1 of the modeling material supply part 510.

Thus, the user may appropriately distinguish a new modeling material S1 from the filtered modeling material S1′ to use the modeling material as needed when the 3D model S is modeled.

The waste container 730 is connected to the filter unit 710 to accommodate a modeling material except for the filtered modeling material, that is, the modeling material that is not filtered. Since the unfiltered modeling material is not recyclable, the unfiltered modeling material may be accommodated in the wasted container 730 and discarded later.

Hereinafter, an operation of the 3D printing apparatus 10 according to an embodiment will be described in detail.

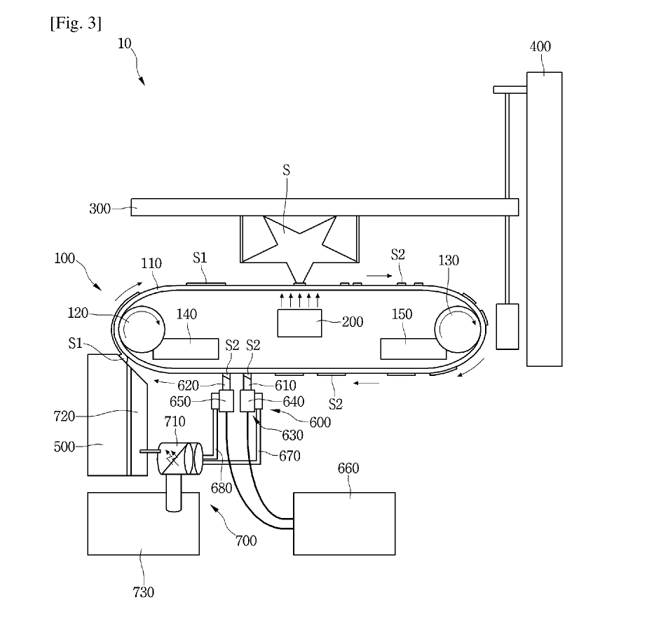

FIG. 3 is a view illustrating an operation of the 3D printing apparatus of FIG. 1.

Referring to FIG. 3, when the first and second belt rollers 120 and 130 of the modeling material circulating part 100 rotate in one direction, the circulation belt 110 circulates in one direction. The modeling material supply part 500 may supply the modeling material S1 corresponding to the build size of the circulating circulation belt 110. Then, the modeling material S1 moves along the circulation belt 110 and is cured while passing through the light source unit 200 and then is seated on the stage 300. Here, the stage 300 may move to be disposed adjacent to the circulation belt 110 for seating of the 3D model S.

Then, the modeling material S1 remaining after the modeling that passes through the light source unit 200 may continuously move along the circulation belt 110. Then, the modeling material S2 remaining after the modeling may be separated from the circulation belt 110 by the first and second collection blades 610 and 620 of the modeling material collecting part 600 and suctioned into each of the first and second suction bodies 640 and 650 of the modeling material collecting part 600.

Then, the modeling material S2 suctioned into each of the first and second suction bodies 640 and 650 may be supplied into the filter unit 710 of the modeling material recycling part 700 through each of the first and second connecting tubes 670 and 680 of the modeling material collecting part 600.

The filter unit 710 may filter the supplied modeling material S2 to supply the filtered recyclable modeling material to the resupply unit 720 and supply the unrecyclable modeling material that needs to be discarded to the waste container 730.

Then, the filtered recyclable modeling material supplied to the resupply unit 720 may be mixed with the modeling material of the modeling material supply part 500 or separately supplied again to the modeling material circulating part 100.

The 3D printing apparatus 10 according to the current embodiment may repeatedly perform the above-described processes until the 3D model S is finished. Like this, in the 3D printing apparatus 10 according to the current embodiment, when the 3D model S is modeled, the modeling material remaining after modeling the 3D model may be recycled through the modeling material collecting part 600 and the modeling material recycling part 700.

Thus, the 3D printing apparatus 10 according to the current embodiment may reduce the modeling material consumed when the 3D model is modeled to significantly reduce costs required according to purchase of the modeling material.

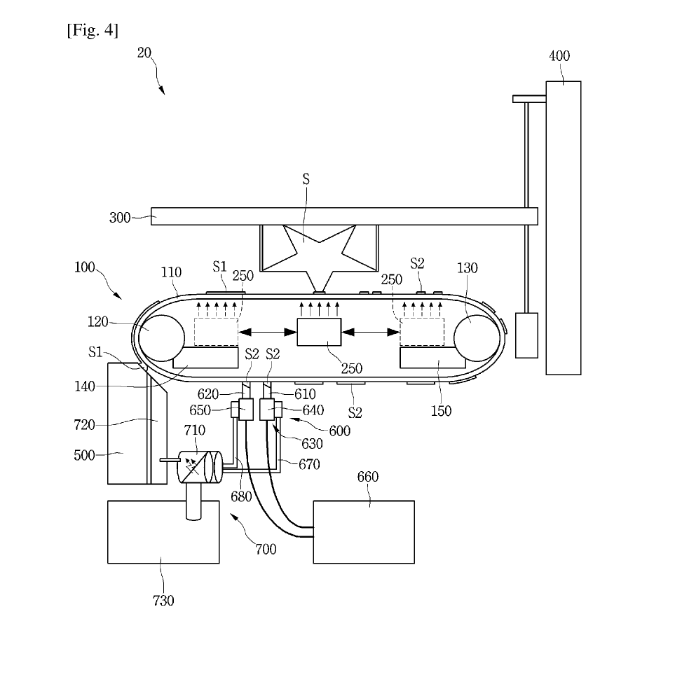

FIG. 4 is a view illustrating a 3D printing apparatus according to another embodiment.

Since a 3D printing apparatus 20 according to the current embodiment is similar to the 3D printing apparatus 10 according to the foregoing embodiment, hereinafter, differences between the current embodiment and the foregoing embodiment will be mainly described.

Referring to FIG. 4, the 3D printing apparatus 20 includes a modeling material circulating part 100, a light source unit 250, a stage 300, a stage driving part 400, a modeling material supply part 500, a modeling material collecting part 600, and a modeling material recycling part 700.

Since the modeling material circulating part 100, the stage 300, the stage driving part 400, the modeling material supply part 500, the modeling material collection part 600, and the modeling material recycling part 700 are the same as those in the foregoing embodiment, hereinafter, the repeated descriptions will be omitted.

The light source unit 250 may be disposed to be movable along a longitudinal direction of the circulation belt 110 of the modeling material circulating part 100. That is, the light source unit 250 according to the current embodiment may be movable without being fixed unlike that in the foregoing embodiment.

Like this, since the 3D printing apparatus 20 according to the current embodiment supplies the light to a relatively wide area by the movable light source unit 250 when compared to the fixed light source unit 250, the 3D printing apparatus 20 may model the 3D model in relatively various and wide areas.

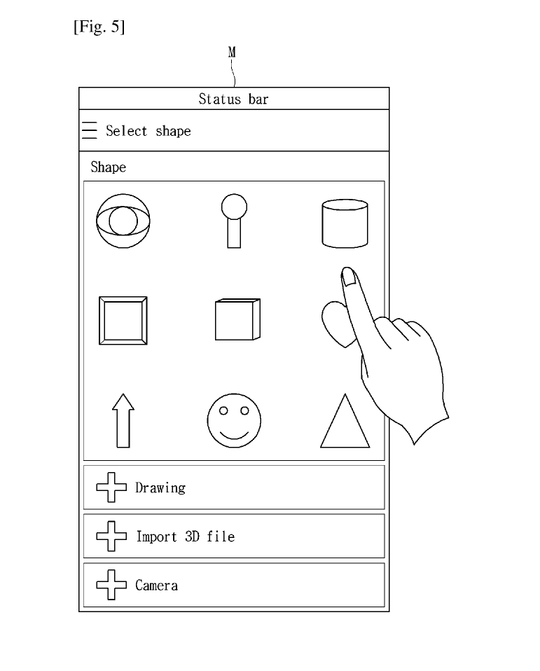

FIGS. 5 to 11 are views illustrating various embodiments in which the 3D printing apparatus of FIG. 1 is controlled by a mobile device.

Hereinafter, various embodiments in which an operation of the 3D printing apparatus (see reference numeral 20 of FIG. 1) is controlled by manipulating a mobile device M will be described.

Referring to FIG. 5, first, the 3D printing apparatus 10 according to the foregoing embodiment may be connected to the mobile device M so that the 3D printing apparatus 10 wirelessly communicates with the mobile device M. Also, the mobile device M is provided with various applications for controlling the operation of the 3D printing apparatus 10. The user may manipulate these applications to control various operations of the 3D printing apparatus. The user may select a desired shape or figure of the 3D model from the mobile device M.

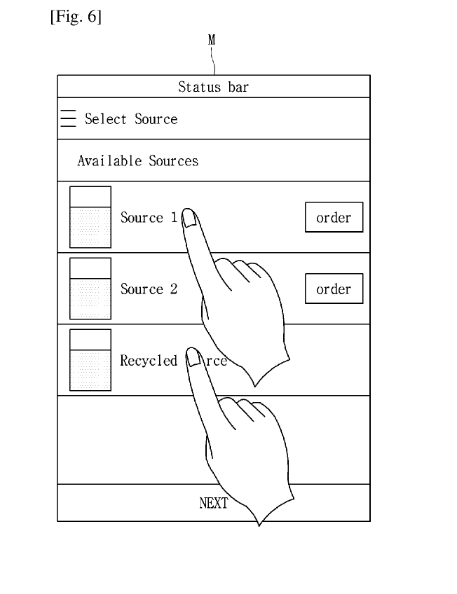

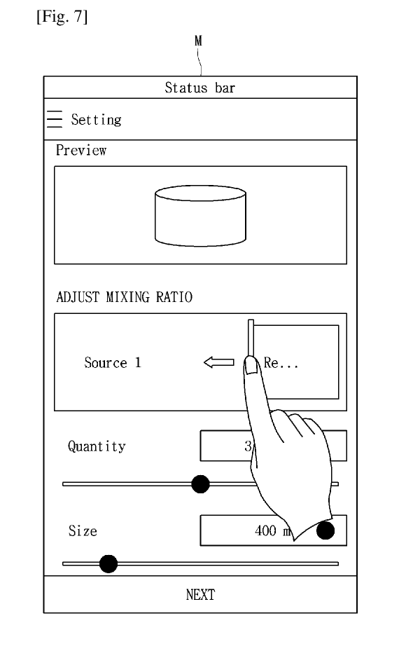

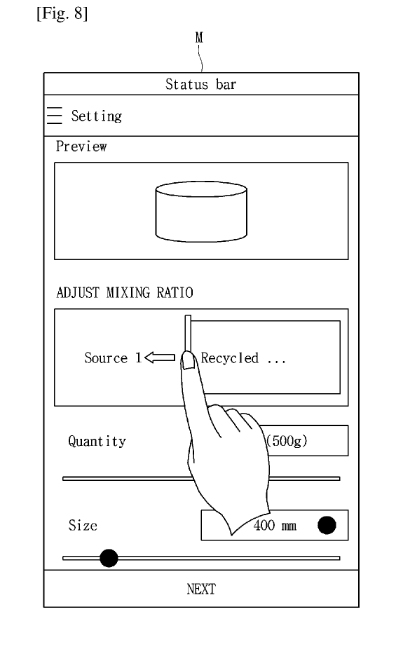

Referring to FIG. 6, the user may select the originally provided modeling material together with the recycled modeling material from the mobile device M. Then, referring to FIGS. 7 and 8, the user may manipulate the mobile device M to adjust a mixing ratio of the originally provided modeling material and the recycled modeling material.

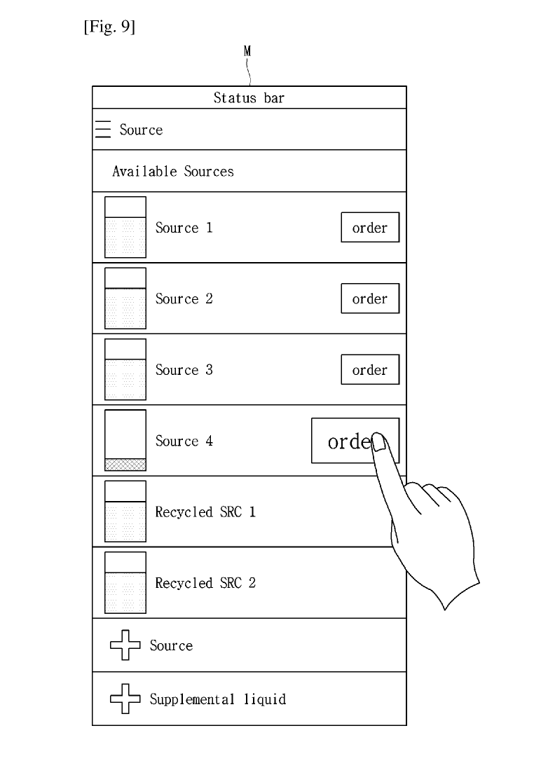

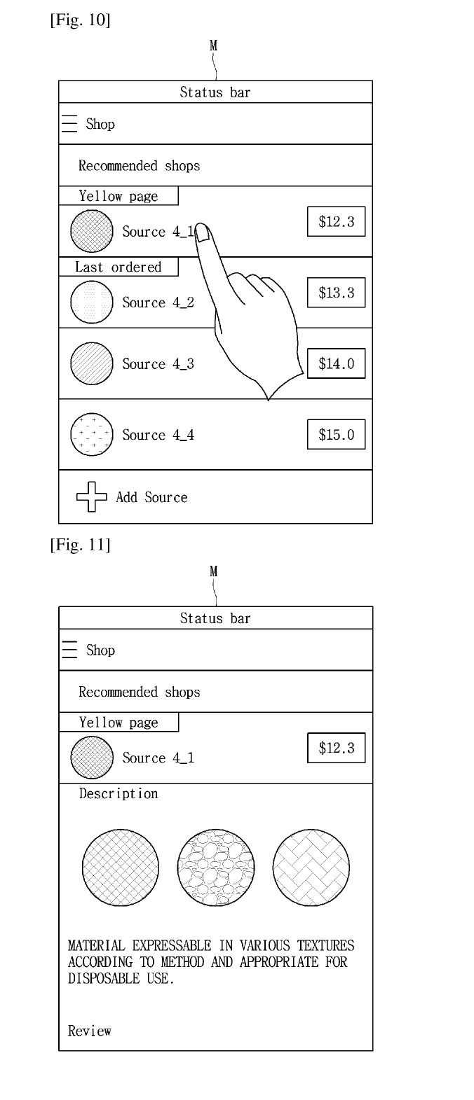

Referring to FIGS. 9 and 10, the user may select a desired modeling material from various modeling materials from the mobile device M. Referring to FIG. 11, after being selected by the user, the mobile device M may provide a description page regarding the selected modeling material.

Like this, the 3D printing apparatus 10 according to the current embodiment may be wirelessly connected to the mobile device M and variously controlled in operation through the manipulation of the mobile device M. Since the foregoing embodiments are provided as examples, various interfaces performed in the 3D printing apparatus 10 may be provided through applications of the mobile device M in addition to the foregoing embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A three-dimensional (3D) printing apparatus comprising:
a modeling material circulating device to circulate a modeling material for modeling a 3D model;
a light source device to supply light to the modeling material such that the modeling material is cured;
a stage to receive the modeling material cured through the light source, wherein the stage is disposed to face the modeling material circulating device;
a stage driving part to provide a driving force for moving the stage;
a modeling material supply device to supply the modeling material to the modeling material circulating device;
a modeling material collecting device to collect the modeling material circulating on the modeling material circulating device; and
a modeling material recycling device coupled to the modeling material collecting device to filter the collected modeling material and to resupply the filtered modeling material to the modeling material circulating device.

2. The 3D printing apparatus according to claim 1, wherein the light source device is disposed inside the modeling material circulating device.

3. The 3D printing apparatus according to claim 2, wherein the modeling material collecting device is disposed outside the modeling material circulating device, and the modeling material recycling device is disposed outside the modeling material circulating device.

4. The 3D printing apparatus according to claim 3, wherein the modeling material circulating device includes:
a circulation belt to circulate the modeling material, wherein the modeling material is to be provided on the circulation belt; and
a plurality of belt rollers disposed inside the circulation belt to provide driving forces for the circulation belt.

5. The 3D printing apparatus according to claim 4, wherein the light source device is disposed inside the circulation belt, the modeling material collecting device is disposed outside the circulation belt, and the modeling material recycling device is disposed outside the circulation belt.

6. The 3D printing apparatus according to claim 4, wherein the modeling material circulating device includes a plurality of roller sensors for respectively controlling revolutions per minute (RPM), and moving distance of different ones of the plurality of belt rollers.

7. The 3D printing apparatus according to claim 4, wherein the light source device is movable along a longitudinal direction of the circulation belt.

8. The 3D printing apparatus according to claim 4, wherein the modeling material collecting device includes:
at least one collection blade to separate the modeling material from the circulation belt;
a suction unit coupled to the at least one collection blade to suction the modeling material separated from the circulation belt by the at least one collection blade; and
a connecting unit connecting the suction unit to the modeling material recycling device such that the modeling material suctioned by the suction unit is supplied to the modeling material recycling device.

9. The 3D printing apparatus according to claim 8, wherein the at least one collection blade includes a plurality of collection blades, and
the plurality of collection blades are spaced apart from each other by a predetermined distance.

10. The 3D printing apparatus according to claim 8, wherein the suction unit includes:
a suction unit body coupled to the collection blade; and
a compressor to provide compressed air to the suction unit body such that the suction unit body suctions the modeling material from the collection blade.

11. The 3D printing apparatus according to claim 4, wherein the modeling material recycling device includes:
a filter device to filter the modeling material supplied from the modeling material collecting device;
a resupply device coupled to the filter device to resupply the modeling material filtered from the filter device to the modeling material circulating device; and
a waste container coupled to the filter device to accommodate the modeling material other than the filtered modeling material.

12. The 3D printing apparatus according to claim 11, wherein the resupply device is integrated with the modeling material supply device.

13. The 3D printing apparatus according to claim 11, wherein the resupply device is disposed a predetermined distance apart from the modeling material supply device.

14. The 3D printing apparatus according to claim 1, wherein the light source device includes an LED array having a plurality of LEDs.

15. The 3D printing apparatus according to claim 1, wherein the modeling material is a photocurable liquid resin composition.

16. A three-dimensional (3D) printing apparatus comprising:
a modeling material circulating device having a circulation belt to circulate modeling material for a 3D model;
a light source device to cure the modeling material by supplying light to the modeling material;
a supply device to supply the modeling material to the circulating device;
a collecting device to collect the modeling material circulating on the circulating device; and
a recycling device connected to the collecting device to filter the collected modeling material and to resupply the filtered modeling material to the circulating device.

17. The 3D printing apparatus according to claim 16, wherein the circulating device includes:
the circulation belt to circulate the modeling material, wherein the modeling material is to be provided on the circulation belt; and
a plurality of belt rollers disposed inside the circulation belt to provide driving forces to the circulation belt.

18. The 3D printing apparatus according to claim 17, wherein the collecting device includes:
at least one collection blade to separate the modeling material from the circulation belt;
a suction unit coupled to the at least one collection blade to suction the modeling material separated from the circulating belt by the at least one collection blade; and
a connecting unit connecting the suction unit to the recycling device such that the modeling material suctioned by the suction unit is supplied to the recycling device.

19. The 3D printing apparatus according to claim 18, wherein the suction unit includes:
a suction unit body coupled to the collection blade; and
a compressor to provide compressed air to the suction unit body such that the suction unit body suctions the modeling material from the collection blade.

20. The 3D printing apparatus according to claim 18, wherein the recycling device includes:
a filter device to filter the modeling material supplied from the collecting device;
a resupply device coupled to the filter device to resupply the modeling material filtered from the filter device to the circulating device; and
a waste container coupled to the filter device to accommodate the modeling material other than the filtered modeling material.
